(19) United States
(12) Patent Application Publication
(10) Pub. No.: US 2013/0189550 A1
(43) Pub. Date: Jul. 25, 2013

(54) COMPOSITE, ITS PRODUCTION AND ITS USE IN SEPARATORS FOR ELECTROCHEMICAL CELLS

(71) Applicants: Nicole Janssen, Bermersheim (DE); Arno Lange, Bad Duerkheim (DE); Helmut Moehwald, Annweiler (DE); Oliver Gronwald, Frankfurt (DE)

(72) Inventors: Nicole Janssen, Bermersheim (DE); Arno Lange, Bad Duerkheim (DE); Helmut Moehwald, Annweiler (DE); Oliver Gronwald, Frankfurt (DE)

(21) Appl. No.: 13/748,243

(22) Filed: Jan. 23, 2013

Related U.S. Application Data
(60) Provisional application No. 61/589,420, filed on Jan. 23, 2012.

(51) Int. Cl. H01M 2/16

(52) U.S. Cl. CPC H01M 2/1633
USPC 429/50; 429/144; 252/182.3; 556/445

(57) ABSTRACT

The present invention relates to a novel composite which comprises at least one base body composed of nonwoven as component (A), at least one nanocomposite as component (B), at least one polyether or at least one polyether-comprising radical as component (C) and optionally a lithium salt as component (D).

The invention further relates to a process for producing the novel composite, its use in separators for electrochemical cells and also specific starting compounds which can be used for producing nanocomposites (B).

The present invention relates to a novel composite which comprises at least one base body composed of nonwoven as component (A), at least one nanocomposite as component (B), at least one polyether or at least one polyether-comprising radical as component (C) and optionally a lithium salt as component (D).

The invention further relates to a process for producing the novel composite, its use in separators for electrochemical cells and also specific starting compounds which can be used for producing nanocomposites (B).

Storage of energy is a subject which has been attracting increasing interest for a long time. Electrochemical cells, for example batteries or accumulators, can serve for the storage of electric energy. Recently, lithium ion batteries have been of particular interest. They are superior to conventional batteries in some technical aspects. Thus, they make it possible to generate voltages which cannot be obtained using batteries based on aqueous electrolytes.

However, conventional lithium ion accumulators which have a carbon anode and a cathode based on metal oxides are limited in terms of their energy density. New dimensions in respect of the energy density have been opened up by lithium-sulfur cells. In lithium-sulfur cells, sulfur is reduced in the sulfur cathode via polysulfide ions to S²⁻ which on charging of the cell is reoxidized to form sulfur-sulfur bonds.

In electrochemical cells, the positively and negatively charged electrode compositions are mechanically separated from one another by layers which are not electrically conductive, known as separators, to avoid internal discharge. Due to their porous structure, these separators allow the transport of ionic charges as basic prerequisite for continuing offtake of current during operation of the battery. Basic requirements which separators have to meet are chemical and electrochemical stability toward both the active electrode compositions and the electrolyte. In addition, a high mechanical strength in respect of the tensile forces occurring during the battery cell production process has to be ensured. On a structural level, a high porosity for the absorption of the electrolyte to ensure a high ion conductivity is necessary. At the same time, pore size and the structure of the channels have to effectively suppress growth of metal dendrites in order to avoid a short circuit, as described in Journal Power Sources 2007, 164, 351-364.

Separators as microporous layers frequently comprise either a polymer membrane or a nonwoven.

At present, polymer membranes based on polyethylene and polypropylene are usually used as separators in electrochemical cells, but these membranes have unsatisfactory stability at elevated temperatures of from 130 to 150° C.

An alternative to the polyolefin separators which are frequently used is separators based on nonwovens which are filled with ceramic particles and additionally are fixed by means of an inorganic binder composed of oxides of the elements silicon, aluminum and/or zirconium, as described in DE10255122 A1, DE10238941 A1, DE10208280 A1, DE10208277 A1 and WO 2005/038959 A1. However, the nonwovens filled with ceramic particles have increased weights per unit area and greater thicknesses compared to the unfilled nonwovens.

WO 2009/033627 discloses a layer which can be used as separator for lithium ion batteries. It comprises a nonwoven and particles which are embedded in the nonwoven and comprise organic polymers and optionally partly an inorganic material. Short circuits caused by metal dendrites are said to be avoided by means of such separators. However, WO 2009/033627 does not disclose any long-term cycling experiments.

WO 2009/103537 discloses a layer having a base body having pores, where the layer further comprises a binder which is crosslinked. In a preferred embodiment, the base body is at least partially filled with particles. The layers disclosed can be used as separators in batteries. However, no electrochemical cells having the layers described are produced and examined in WO 2009/103537.

WO 2011/000858 describes a porous film material which comprises at least one carbon-comprising semimetal oxide phase and can be used as separator in rechargeable lithium ion cells. The carbon-comprising semimetal oxide phase is obtained by means of a twin polymerization as described by S. Spange et al. in Angew. Chem. Int Ed., 46 (2007) 628-632.

The separators known from the literature still have deficiencies in respect of one or more of the properties desired for the separators, for example low thickness, low weight per unit area, good mechanical stability during processing, e.g. high flexibility or low abrasion, or in operation of the battery in respect of metal dendrite growth, good heat resistance, low shrinkage, high porosity, good ion conductivity and good wettability with the electrolyte liquids. Some of the deficiencies of the separators are ultimately responsible for a reduced life of the electrochemical cells comprising them. Furthermore, separators in principle have to be not only mechanically but also chemically stable toward the cathode materials, the anode materials and the electrolytes. In the field of lithium-sulfur cells, separators which also prevent early cell death of lithium-sulfur cells, which is brought about particularly by migration of polysulfide ions from the cathode to the anode, are desirable.

It was therefore an object of the invention to provide an inexpensive separator for a long-lived electrochemical cell, in particular a lithium-sulfur cell, which has advantages in respect of one or more properties of a known separator, in particular a separator which displays good lithium ion permeability, high thermal stability and good mechanical properties.

This object is achieved by a composite comprising the components

(A) at least one base body composed of nonwoven;
(B) at least one nanocomposite comprising
(a) at least one inorganic or (semi)metal-organic phase (a) which comprises at least one metal or semimetal M; and
(b) at least one organic polymer phase (b), where the organic polymer phase (b) and the inorganic or (semi)metal-organic phase (a) form essentially cocontinuous phase domains and the average distance between two adjacent domains of identical phases is not more than 100 nm;
   (C) at least one polyether or at least one polyether-comprising radical, where the polyether-comprising radical is covalently bound to the (semi)metal-organic phase (a) or organic polymer phase (b); and
   (D) optionally, at least one lithium salt.

The composites of the invention are composite materials which for the purposes of the present invention will also be referred to as composites of the invention. In general, composite materials are materials which are solid mixtures which cannot be separated manually and have different properties than the individual components. Specifically, the composites of the invention are fiber composites.

Depending on the ratio of the total volume of the base body composed of nonwoven (A) to the total volume of the nanocomposite (B) and depending on the method of bringing the component (A) into contact with the component (B), the base body composed of nonwoven (A) can have been penetrated partially to completely by the nanocomposite (B). Here, the base body composed of nonwoven can have been penetrated symmetrically or unsymmetrically, i.e. opposite sides of the base body composed of nonwoven can be distinguished from one another.

In an embodiment of the present invention, the base body composed of nonwoven (A) in the composite of the invention can have been penetrated at least partially, preferably to an extent of more than 50%, in particular completely, by the nanocomposite (B).

The composite of the invention comprises, as component (A), at least one base body composed of nonwoven, for the purposes of the invention also referred to as nonwoven (A) for short.

Nonwovens and their production are known to those skilled in the art. A large choice of nonwovens is available commercially. Thus, a nonwoven can be produced from inorganic or organic materials, preferably from organic materials.

Examples of inorganic nonwovens are glass fiber nonwovens and ceramic fiber nonwovens.

Examples of organic polymers for producing nonwovens are polyolefins, in particular polyethylene or polypropylene, polymers of heteroatom-comprising vinyl monomers, in particular polyacrylonitrile, polyvinylpyrrolidone or polyvinylidene fluoride, polyesters, in particular polybutyl terephthalate, polyethylene terephthalate or polyethylene naphthalate, polyamides, in particular PA 6, PA 11, PA 12, PA 6.6, PA 6.10 or PA 6.12, polyimides, polyether ether ketones, polysulfones or polyoxymethylene.

In an embodiment of the present invention, the base body composed of nonwoven (A) in the composite of the invention is made of organic polymers selected from the group of polymers consisting of polyolefins, in particular polyethylene and polypropylene, polymers of heteroatom-comprising vinyl monomers, in particular polyacrylonitrile, polyvinylpyrrolidone and polyvinylidene fluoride, polyesters, in particular polybutyl terephthalate, polyethylene terephthalate and polyethylene naphthalate, polyamides, in particular PA 6, PA 11, PA 12, PA 6.6, PA 6.10 and PA 6.12, polyimides, polyether ether ketones, polysulfones and poly-oxymethylene. Particular preference is given to nonwovens (A) made of polyester, in particular polyethylene terephthalate.

The base body composed of nonwoven is preferably a sheet-like base body; for the purposes of the present invention, the expression “sheet-like” means that the base body described, a three-dimensional body, is smaller in one of its three spatial dimensions (extensions), namely the thickness, than in respect of the other two dimensions, the length and width. The thickness of the base body is usually a factor of 5, preferably at least a factor of 10, particularly preferably at least a factor of 20, smaller than the second-largest dimension.

Accordingly, the composite comprising the base body (A) is preferably also a sheet-like body.

In an embodiment of the present invention, the composite material of the invention is a sheet-like body.

The base body composed of nonwoven preferably has a thickness in the range from 5 to 100 μm, particularly preferably from 10 to 50 μm, in particular from 15 to 25 μm. The fibers of which the nonwoven is made usually have a fiber length which preferably exceeds the average diameter of the fibers by a factor of at least two, preferably a factor of more than two. The average diameter of at least 90% of the fibers comprised in the nonwoven is preferably not more than 20 μm, particularly preferably not more than 12 μm, in particular in the range from 4 to 6 μm. The porosity of the base body composed of nonwoven is preferably in the range from 50 to 80%, preferably in the range from 50 to 60%.

The composite of the invention further comprises, as component (B), at least one nanocomposite, for the purposes of the present invention also referred to as nanocomposite (B) for short, which comprises
(a) at least one inorganic or (semi)metal-organic phase (a) which comprises at least one metal or semimetal M; and
(b) at least one organic polymer phase (b), where the organic polymer phase (b) and the inorganic or (semi)metal-organic phase (a) form essentially cocontinuous phase domains and the average distance between two adjacent domains of identical phases is not more than 100 nm, preferably not more than 40 nm, particularly preferably not more than 10 nm, in particular not more than 5 nm.

Nanocomposites (B) as defined above are known in principle and are available in various macroscopic forms in which the microscopic structure of the phases (a) and phases (b) essentially corresponds, i.e. phase (a) and phase (b) essentially form cocontinuous phase domains, where the average distance between two adjacent domains of identical phases is not more than 100 nm.

WO2010/112581, pages 30 to 31, describes various nanocomposites (B) as solids. WO 2010/128144, page 38, line 1 to page 41, line 26 describes particulate nanocomposites (B) and WO 2011/000858, page 6, line 24 to page 12, line 28 describes nanocomposites (B) as porous film materials. As regards the preferred embodiments of the nanocomposite (B) and the explanations of the terms phases and phase domains, the references mentioned are fully incorporated by reference into the description of the present invention.

The metal or semimetal M in the inorganic or (semi)metal-organic phase (a) is preferably selected from among B, Al, Si, Ti, Zr, Hf, Ge, Sn, Pb, V, As, Sb, Bi and mixtures thereof. In particular, M is selected from among B, Al, Si, Ti, Zr and Sn, preferably from among Al, Si, Ti and Zr, in particular Si. Particular preference is given to at least 90 mol %, especially at least 99 mol % or the total amount, of all metals or semimetals M being silicon.

In an embodiment of the present invention, the metal or semimetal M of the phase (a) in the composite of the invention is selected from among B, Al, Si, Ti, Zr, Hf, Ge, Sn, Pb, V, As, Sb, Bi and mixtures thereof, preferably selected from among B, Al, Si, Ti, Zr and Sn, particularly preferably selected from among Al, Si, Ti and Zr, in particular selected as Si.

In a further embodiment of the present invention, the metal or semimetal M in the composite of the invention comprises at least 90 mol %, in particular at least 99 mol %, based on the total amount of M, of silicon.

Furthermore, the composite of the invention comprises, as component (C), at least one polyether or at least one polyether-comprising radical, where the polyether-comprising radical is covalently bound to the (semi)metal-organic phase (a) or organic polymer phase (b).

Polyethers and their preparation are known in principle to those skilled in the art. Thus, many polyethers are commercially available. Many of these polyethers preferably comprise the monomer building blocks ethylene oxide or propylene oxide, in particular ethylene oxide. Both cyclic and linear polyethers are known. An example of a defined cyclic polyether is [18]crown-6. Examples of linear polyethers are, in particular, polyalkylene glycols, preferably poly-C₁-C₄-alkylene glycols and in particular polyethylene glycols. Polyethylene glycols can comprise up to 20 mol % of one or more C₁-C₄-alkylene glycols in copolymerized form. Polyalkylene glycols are preferably polyalkylene glycols having two methyl or ethyl end caps. The molecular weight M_{w} of suitable polyalkylene glycols and in particular of suitable polyethylene glycols can be in the range from 200 g/mol to 100 000 g/mol, preferably from 400 g/mol to 10 000 g/mol. Polyethers preferred as component (C) are selected from the group consisting of polyethylene glycols, polypropylene glycols and copolymers of ethylene oxide and propylene oxide.

Polyether-comprising radicals, their production and handling are likewise known to those skilled in the art. Since polyether-comprising radicals are in principle derived from a polyether as described above, for example by abstraction of a hydrogen atom from a hydrocarbon fragment or preferably an OH group of the polyether concerned, the polyether-comprising radicals are also based, in particular, on the monomer building blocks ethylene oxide or propylene oxide, in particular ethylene oxide.

The polyether-comprising radical which is covalently bound to the (semi)metal-organic phase (a) or organic polymer phase (b) is preferably bound directly via an oxygen atom of the polyether-comprising radical or in particular via a divalent hydrocarbon fragment, for example a methylene group, ethylene group, propylene group or a phenylene group, to one of the two phases. A polyether-comprising radical comprising monomer units selected from the group consisting of ethylene oxide and propylene oxide is particularly preferably bound via a carbon atom to the (semi)metal-organic phase (a), in particular to the metal or semimetal M of the (semi)metal-organic phase (a), in particular to Si.

The proportion by weight of the total component (C), i.e. of the at least one polyether or the at least one polyether-comprising radical, based on the total weight of the composite material is preferably in the range from 5 to 60% by weight, particularly preferably from 30 to 50% by weight. The proportion by weight of the total nanocomposite (B) based on the total weight of the composite is preferably at least 20% by weight, particularly preferably at least 30% by weight, and can be up to 99% by weight, preferably up to 95% by weight.

The composite of the invention can optionally comprise at least one lithium salt as component (D). The composite of the invention preferably comprises at least one lithium salt as component (D).

The component (D) is, in particular, a lithium salt which is usually used as electrolyte salt in lithium ion cells. The lithium salt (D) is particularly preferably selected from the group consisting of lithium hexafluorophosphate, lithium perchlorate, lithium hexafluoroarsenate, lithium trifluoromethylsulfonate, lithium bis(trifluoromethylsulfonyl)imide and lithium tetrafluoroborate.

In a further embodiment of the present invention, the lithium salt (D) in the composite of the invention is selected from the group consisting of lithium hexafluorophosphate, lithium perchlorate, lithium hexafluoroarsenate, lithium trifluoromethylsulfonate, lithium bis(trifluoromethylsulfonyl)imide and lithium tetrafluoroborate.

To increase the thermal stability, the composite of the invention can comprise, as further constituent, a component (E) which is at least one inorganic (semi)metal oxide in the form of particles. Examples of such inorganic (semi)metal oxides are silicates, aluminates, titanium dioxides, barium titanate, zirconium dioxide and yttrium oxide.

The component (B) of the composite of the invention, namely the nanocomposite (B), is preferably a polymerization product of at least one monomer AB which
has at least one first cationically polymerizable monomer unit A which comprises a metal or semimetal M and
has at least one second cationically polymerizable organic monomer unit B which is bound via one or more covalent chemical bonds to the polymerizable monomer unit A,
   where the polymerization product is obtained under cationic polymerization conditions under which both the polymerizable monomer unit A and the polymerizable monomer unit B polymerize with rupture of the bond between A and B and the monomer AB is polymerized in the presence of the base body composed of nonwoven (A), the polyether or the polyether-comprising radical (C) and optionally the lithium salt (D).

In a further embodiment of the present invention, the nanocomposite (B) in the composite of the invention is a polymerization product of at least one monomer AB which
has at least one first cationically polymerizable monomer unit A which comprises a metal or semimetal M and
has at least one second cationically polymerizable organic monomer unit B which is bound via one or more covalent chemical bonds to the polymerizable monomer unit A,
   where the polymerization product is obtained under cationic polymerization conditions under which both the polymerizable monomer unit A and the polymerizable monomer unit B polymerize with rupture of the bond between A and B and the monomer AB is polymerized in the presence of the base body composed of nonwoven (A), the polyether or the polyether-comprising radical (C) and optionally the lithium salt (D).

The composites of the invention are produced by a process comprising a twin polymerization of the monomers AB detailed below under cationic polymerization conditions, in which the monomer AB is polymerized in the presence of the base body composed of nonwoven (A), the polyether or the polyether-comprising radical (C) and optionally the lithium salt (D). The components (A), (C) and (D) have been explained above. The principle of twin polymerization of “twin monomers” is described, for example, in WO 2010/112581, page 2, line 16 to page 4, line 11 or in WO 2011/000858, page 14, line 29 to page 16, line 7. A twin polymerization of two different (twin) monomers is explained comprehensively in, for example, WO 2011/000858, page 16, line 9 to page 24, line 11.

The present invention therefore also provides a process for producing a composite comprising the components

(A) at least one base body composed of nonwoven;
(B) at least one nanocomposite comprising
(a) at least one inorganic or (semi)metal-organic phase (a) which comprises at least one metal or semimetal M; and
(b) at least one organic polymer phase (b);
   in particular a nanocomposite where the organic polymer phase (b) and the inorganic or (semi)metal-organic phase (a) form essentially cocontinuous phase domains and the average distance between two adjacent domains of identical phases is not more than 100 nm;
      (C) at least one polyether or at least one polyether-comprising radical, where the polyether-comprising radical is covalently bound to the (semi)metal-organic phase (a) or organic polymer phase (b); and
      (D) optionally a lithium salt;
      by polymerization of at least one monomer AB which
has at least one first cationically polymerizable monomer unit A which comprises a metal or semimetal M and
has at least one second cationically polymerizable organic monomer unit B which is bound via one or more covalent chemical bonds to the polymerizable monomer unit A,
   under cationic polymerization conditions under which both the polymerizable monomer unit A and the polymerizable monomer unit B polymerize with rupture of the bond between A and B, where the polymerization is carried out in the presence of the base body composed of nonwoven (A), the polyether or the polyether-comprising radical (C) and optionally the lithium salt (D).

The description and preferred embodiments of the components (A), (B), (C) and (D) in the process of the invention correspond to the above description of these components for the composite of the invention.

The metal or semimetal M of the monomer unit A in the monomers AB is preferably selected from among B, Al, Si, Ti, Zr, Hf, Ge, Sn, Pb, V, As, Sb, Bi and mixtures thereof. In particular, M is selected from among B, Al, Si, Ti, Zr and Sn, preferably from among Al, Si, Ti and Zr, in particular Si. Particular preference is given to at least 90 mol %, especially at least 99 mol % or the total amount, of all metals or semimetals M being silicon.

In an embodiment of the present invention, the metal or semimetal M of the monomer unit A in the monomers AB used in the process of the invention for producing a composite is selected from among B, Al, Si, Ti, Zr, Hf, Ge, Sn, Pb, V, As, Sb, Bi and mixtures thereof, preferably selected from among B, Al, Si, Ti, Zr and Sn, particularly preferably selected from among Al, Si, Ti and Zr, and is in particular selected as Si.

In a further embodiment of the present invention, the metal or semimetal M of the monomer unit A in the process of the invention for producing a composite comprises at least 90 mol %, in particular at least 99 mol %, based on the total amount of M, of silicon.

The process of the invention for producing a composite is preferably carried out using monomers AB which have at least one monomer unit A and at least one monomer unit B and are described by the general formula I,

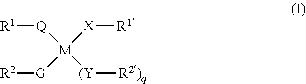

where
M is a metal or semimetal;
R¹, R² can be identical or different and are each a radical Ar—C(R^{a},R^{b})— where Ar is an aromatic or heteroaromatic ring which optionally has one or two substituents selected from among halogen, CN, C₁-C₆-alkyl, C₁-C₆-alkoxy and phenyl and R^{a}, R^{b} are each, independently of one another, hydrogen or methyl or together represent an oxygen atom or a methylidene group (═CH₂),
   or the radicals R¹Q and R²G together form a radical of the formula Ia

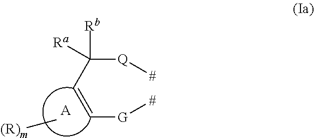

where A is an aromatic or heteroaromatic ring fused onto the double bond, m is 0, 1 or 2, the radicals R can be identical or different and are selected from among halogen, CN, C₁-C₆-alkyl, C₁-C₆-alkoxy and phenyl and R^{a}, R^{b} are as defined above;
G is O, S or NH, in particular O;
Q is O, S or NH, in particular O;
q is, according to the valence of M, 0, 1 or 2,
X, Y can be identical or different and are each O, S, NH or a chemical bond, in particular O or a chemical bond;
R^{1′}, R^{2′} can be identical or different and are each C₁-C₆-alkyl, C₃-C₆-cycloalkyl, a polyether-comprising radical comprising monomer units selected from the group consisting of ethylene oxide and propylene oxide, or aryl or a radical Ar′—C(R^{a′},R^{b′})—, where Ar′ has the meanings given for Ar and R^{a′}, R^{b′} have the meanings given for R^{a}, R^{b} or R^{1′}, R^{2′} together with X and Y form a radical of the formula Ia as defined above;
   or, when X is oxygen, the radical R^{1′} can be a radical of the formula Ib:

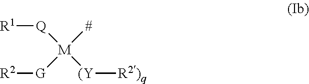

where q, R¹, R², R^{2′}, Y, Q and G are as defined above and # represents the bond to X.

In the monomers of the formula I, the parts of the molecule corresponding to the radicals R¹ and R²G form polymerizable unit(s) B. When X and Y are different from a chemical bond and R^{1′}X and R^{2′} are not inert radicals such as C₁-C₆-alkyl, C₃-C₆-cycloalkyl or aryl, the radicals R^{1′}X and R^{2′}Y likewise form polymerizable unit(s) B. On the other hand, the metal atom M, optionally together with the groups Q and Y, forms the main constituent of the monomer unit A.

For the purposes of the invention, an aromatic radical, or aryl, is a carbocyclic aromatic hydrocarbon radical such as phenyl or naphthyl.

For the purposes of the invention, a heteroaromatic radical, or hetaryl, is a heterocyclic aromatic radical which generally has 5 or 6 ring atoms, where one of the ring atoms is a heteroatom selected from among nitrogen, oxygen and sulfur and one or two further ring atoms can optionally be a nitrogen atom and the remaining ring atoms are carbon. Examples of heteroaromatic radicals are furyl, thienyl, pyrrolyl, pyrazolyl, imidazolyl, oxazolyl, isoxazolyl, pyridyl, pyrimidyl, pyrazinyl or thiazolyl.

For the purposes of the invention, a fused aromatic radical or ring is a carbocyclic aromatic, divalent hydrocarbon radical such as o-phenylene (benzo) or 1,2-naphthylene (naphtho).

For the purposes of the invention, a fused heteroaromatic radical or ring is a heterocyclic aromatic radical as defined above in which two adjacent carbon atoms form the double bond shown in formula Ia or in formulae II and III.

The metal or semimetal M in formula I is, in particular, one of the embodiments of M indicated as preferred in the description of the composite.

In a first embodiment of the monomers of the formula I, the groups R¹Q and R²G together form a radical of the formula Ia as defined above, in particular a radical of the formula Iaa:

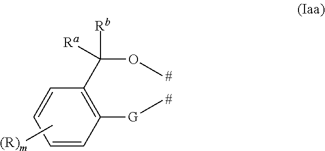

where #, m, R, R^{a} and R^{b} are as defined above. In the formulae Ia and Iaa, the variable m is in particular 0. If m is 1 or 2, R is, in particular, a methyl or methoxy group. In the formulae Ia and Iaa, R^{a} and R^{b} are in particular hydrogen. In formula Ia, Q is in particular oxygen. In the formulae Ia and Iaa, G is in particular oxygen or NH, in particular oxygen.

Among the monomers of the first embodiment, particular preference is given to monomers of the formula I in which q=1 and the groups X—R^{1′} and Y—R^{2′} together form a radical of the formula Ia, in particular a radical of the formula Iaa. Such monomers can be described by the formulae II and IIa:

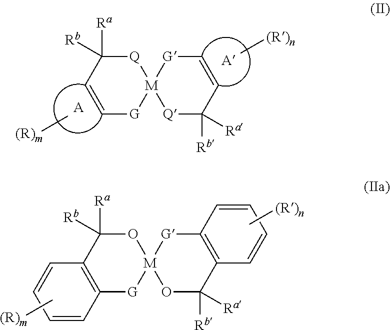

Among the twin monomers of the first embodiment, preference is also given to monomers of the formula I in which q is 0 or 1 and the group X—R^{1′} is a radical of the formula Ia′ or Iaa′:

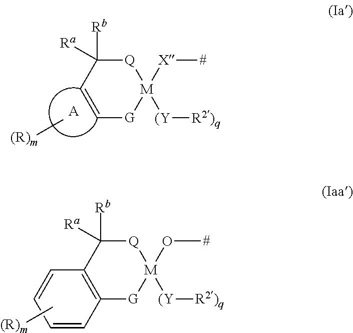

where m, A, R, R^{a}, R^{b}, G, Q, X″, Y, R^{2′} and q have the meanings given above, in particular the meanings indicated as preferred.

Such monomers can be described by the formulae II′ and IIa′:

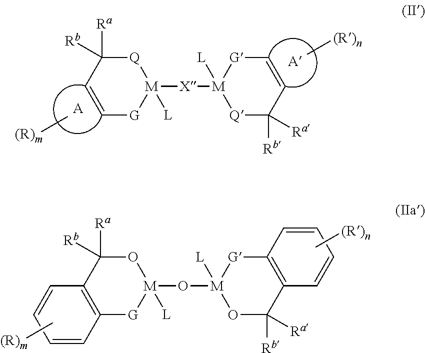

In the formulae II and II′, the variables have the following meanings:
M is a metal or semimetal, preferably B, Al, Si, Ti, Zr, Hf, Ge, Sn, Pb, V, As, Sb or Bi, particularly preferably B, Al, Si, Ti, Zr or Sn, very particularly preferably Al, Si, Ti or Zr, in particular Si;
A, A′ are each, independently of one another, an aromatic or heteroaromatic ring fused onto the double bond;
m, n are each, independently of one another, 0, 1 or 2, in particular 0;
G, G′ are each, independently of one another, O, S or NH, in particular O or NH and especially O;
Q, Q′ are each, independently of one another, O, S or NH, in particular O;
R, R′ are selected independently from among halogen, CN, C₁-C₆-alkyl, C₁-C₆-alkoxy and phenyl and are in particular, independently of one another, methyl or methoxy;
R^{a}, R^{b}, R^{a′}, R^{b′} are selected independently from among hydrogen and methyl or R^{a} and R^{b} and/or R^{a′} and R^{b′} in each case together represent an oxygen atom or ═CH₂; in particular, R^{a}, R^{b}, R^{a′}, R^{b′} are each hydrogen;
L is a group (Y—R^{2′})_{q}, where Y, R^{2′} and q are as defined above and
X″ has one of the meanings given for Q and is in particular oxygen.

In the formulae IIa and IIa′, the variables have the following meanings:
M is a metal or semimetal, preferably B, Al, Si, Ti, Zr, Hf, Ge, Sn, Pb, V, As, Sb or Bi, particularly preferably B, Al, Si, Ti, Zr or Sn, very particularly preferably Al, Si, Ti or Zr, in particular Si;
m, n are each, independently of one another, 0, 1 or 2, in particular 0;
G, G′ are each, independently of one another, O, S or NH, in particular O or NH and especially O;
R, R′ are selected independently from among halogen, CN, C₁-C₆-alkyl, C₁-C₆-alkoxy and phenyl and are in particular methyl or methoxy;
R^{a}, R^{b}, R^{a′}, R^{b′} are selected independently from among hydrogen and methyl or R^{a} and R^{b} and/or R^{a′} and R^{b′} in each case together represent an oxygen atom; in particular, R^{a}, R^{b}, R^{a′}, R^{b′} are each hydrogen;
L is a group (Y—R^{2′})_{q}, where Y, R^{2′} and q are as defined above.

An example of a monomer of the formula II or IIa is 2,2′-spirobis[4H-1,3,2-benzodioxasilin] (compound of the formula IIa where M=Si, m=n=0, G=G′=O, R^{a}=R^{b}=R^{a′}=R^{b′}=hydrogen). Such monomers are known from WO2009/083082 and WO2009/083083 or can be prepared by the methods described there. A further example of a monomer IIa is 2,2-spirobis[4H-1,3,2-benzodioxaborin] (Bull. Chem. Soc. Jap. 51 (1978) 524): (compound of the formula IIa where M=B, m=n=0, G=O, R^{a}=R^{b}=R^{a′}=R^{b′}=hydrogen). A further example of a monomer IIa′ is bis(4H-1,3,2-benzodioxaborin-2-yl)oxide (compound of the formula IIa′ where M=B, m=n=0, L absent (q=0), G=O, R^{a}=R^{b}=R^{a′}=R^{b′}=hydrogen; Bull. Chem. Soc. Jap. 51 (1978) 524).

In the monomers II and IIa, the unit MQQ′ or MO₂ forms the polymerizable unit A, while the remaining parts of the monomer II or IIa, i.e. the groups of the formula Ia or Iaa minus the atoms Q or Q′ (or minus the oxygen atom in Iaa), form the polymerizable units B.

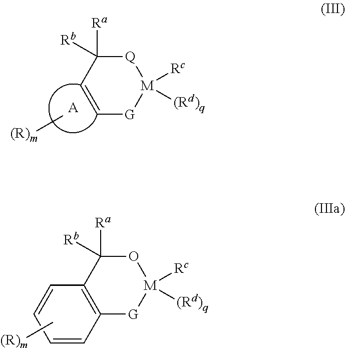

In formula III, the variables have the following meanings:
M is a metal or semimetal, preferably B, Al, Si, Ti, Zr, Hf, Ge, Sn, Pb, V, As, Sb or Bi, particularly preferably B, Al, Si, Ti, Zr or Sn, very particularly preferably Al, Si, Ti or Zr, in particular Si;
A is an aromatic or heteroaromatic ring fused onto the double bond;
m is 0, 1 or 2, in particular 0;
G is O, S or NH, in particular O or NH and especially O;
Q is O, S or NH, in particular O;
q is, depending on the valence and charge on M, 0, 1 or 2;
R is selected independently from among halogen, CN, C₁-C₆-alkyl, C₁-C₆-alkoxy and phenyl and are in particular methyl or methoxy;
R^{a}, R^{b} are selected independently from among hydrogen and methyl or R^{a} and R^{b} can together represent an oxygen atom or ═CH₂ and are in particular both hydrogen;
R^{c}, R^{d} are identical or different and are each selected from among C₁-C₆-Alkyl, C₃-C₆-cycloalkyl, polyether-comprising radicals comprising monomer units selected from the group consisting of ethylene oxide and propylene oxide, and aryl and are in particular methyl.

In formula IIIa, the variables have the following meanings:
M is a metal or semimetal, preferably B, Al, Si, Ti, Zr, Hf, Ge, Sn, Pb, V, As, Sb or Bi, particularly preferably B, Al, Si, Ti, Zr or Sn, very particularly preferably Al, Si, Ti or Zr, in particular Si;
m is 0, 1 or 2, in particular 0;
G is O, S or NH, in particular O or NH and especially O;
R radicals R are selected independently from among halogen, CN, C₁-C₆-alkyl, C₁-C₆-alkoxy and phenyl and are in particular methyl or methoxy;
R^{a}, R^{b} are selected independently from among hydrogen and methyl or R^{a} and R^{b} can together represent an oxygen atom or ═CH₂ and are in particular both hydrogen;
R^{c}, R^{d} are identical or different and are each selected from among C₁-C₆-Alkyl, C₃-C₆-cycloalkyl, polyether-comprising radicals comprising monomer units selected from the group consisting of ethylene oxide and propylene oxide, and aryl and are in particular methyl.

Examples of monomers of the formula III or IIIa are 2,2-dimethyl-4H-1,3,2-benzodioxasilin (compound of the formula IIIa where M=Si, q=1, m=0, G=O, R^{a}=R^{b}=hydrogen, R^{c}=R^{d}=methyl), 2,2-dimethyl-4H-1,3,2-benzooxazasilin (compound of the formula IIIa where M=Si, q=1, m=0, G=NH, R^{a}=R^{b}=hydrogen, R^{c}=R^{d}=methyl), 2,2-dimethyl-4-oxo-1,3,2-benzodioxasilin (compound of the formula IIIa where M=Si, q=1, m=0, G=O, R^{a}+R^{b}=O, R^{c}=R^{d}=methyl) and 2,2-dimethyl-4-oxo-1,3,2-benzooxazasilin, (compound of the formula IIIa where M=Si, q=1, m=0, G=NH, R^{a}+R^{b}=O, R^{c}=R^{d}=methyl). Such monomers are known, e.g. from Wieber et al. Journal of Organometallic Chemistry, 1, 1963, 93, 94. Further examples of monomers IIIa are 2,2-diphenyl[4H-1,3,2-benzodioxasilin] (J. Organomet. Chem. 71 (1974) 225);
2,2-di-n-butyl[4H-1,3,2-benzodioxastannin] (Bull. Soc. Chim. Belg. 97 (1988) 873);
2,2-dimethyl[4-methylidene-1,3,2-benzodioxasilin] (J. Organomet. Chem., 244, C5-C8 (1983));
2-methyl-2-vinyl[4-oxo-1,3,2-benzodioxazasilin].

The monomers of the formula III and IIIa are preferably not polymerized alone but are copolymerized in combination with the monomers of the formula II or IIa.

In a further embodiment, the monomers AB of the general formula I are monomers described by the general formula IV,

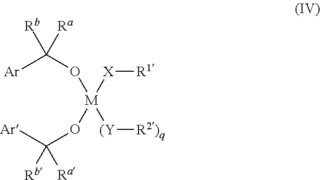

where
M is a metal or semimetal, preferably B, Al, Si, Ti, Zr, Hf, Ge, Sn, Pb, V, As, Sb or Bi, particularly preferably B, Al, Si, Ti, Zr or Sn, very particularly preferably Al, Si, Ti or Zr, in particular Si;
Ar, Ar′ are identical or different and are each an aromatic or heteroaromatic ring which optionally has one or two substituents selected from among halogen, CN, C₁-C₆-alkyl, C₁-C₆-alkoxy and phenyl;
R^{a}, R^{b}, R^{a′}, R^{b′} are selected independently from among hydrogen and methyl or R^{a} and R^{b} and/or R^{a′} and R^{b′} in each case together represent an oxygen atom;
q is, depending on the valence of M, 0, 1 or 2;
X, Y can be identical or different and are each O, S, NH or a chemical bond; and
R^{1′}, R^{2′} can be identical or different and are each C₁-C₆-alkyl, C₃-C₆-cycloalkyl, a polyether-comprising radical comprising monomer units selected from the group consisting of ethylene oxide and propylene oxide, or aryl or a radical Ar″—C(R^{a″},R^{b″})—where Ar″ has the meanings given for Ar and R^{a″}, R^{b″} have the meanings given for R^{a}, R^{b} or R^{1′}, R^{2′} together with X and Y form a radical of the formula A.

In a preferred embodiment of the process of the invention, the monomer AB is not polymerized alone but is copolymerized in combination with at least one monomer A1B1, where the monomer AB has at least one first cationically polymerizable monomer unit A having a metal or semimetal M and at least one radical which is covalently bound via a carbon atom to M and is selected from the group consisting of C₁-C₂₀-hydrocarbon radicals and polyether-comprising radicals.

In a preferred embodiment of the present invention, the polymerization of at least one monomer AB in the process of the invention for producing a composite is a copolymerization of at least one monomer AB which
has at least one first cationically polymerizable monomer unit A having a metal or semimetal M and at least one radical which is selected from the group consisting of C₁-C₂₀-hydrocarbon radicals, preferably C₁-C₄-alkyl, in particular methyl, and polyether-comprising radicals, in particular a polyether-comprising radical comprising monomer units selected from the group consisting of ethylene oxide and propylene oxide, preferably ethylene oxide, and is covalently bound via a carbon atom to M and
has at least one second cationically polymerizable organic monomer unit B which is bound via one or more covalent chemical bonds to the polymerizable unit A,
   with at least one monomer A1B1 which
has at least one first cationically polymerizable monomer unit A1 having a metal or semimetal M and
has at least one second cationically polymerizable organic monomer unit B1 which is bound via one or more covalent chemical bonds to the polymerizable monomer unit A1,
   where the copolymerization is carried out under cationic polymerization conditions under which both the polymerizable monomer units A and A1 and also the polymerizable monomer units B and B1 polymerize with rupture of the bond between A and B and with rupture of the bond between A1 and B1.

In a preferred embodiment, the metals or semimetals M in the monomers AB and in the monomers A1B1 used in the copolymerization of the monomers AB with the monomers A1B1 are each, independently of one another, Si, Al, Ti or Zr, in particular Si and the cationically polymerizable organic monomer units B and B1 in the corresponding monomers AB and A1B1 are each covalently bound via one or more oxygen atoms to M.

In a further preferred embodiment, the metal or semimetal M in the monomer AB used in the copolymerization of the monomers AB with the monomers A1B1 is Si and the monomer unit A has two identical or different radicals which are selected from the group consisting of C₁-C₁₈-alkyl, vinyl, C₆-C₁₀ aryl, C₇-C₁₄-alkylaryl and polyether-comprising radicals comprising monomer units selected from the group consisting of ethylene oxide and propylene oxide, in particular ethylene oxide, and are each bound via a carbon atom to Si.

The monomer A1B1 is in principle defined in the same way as the monomer AB and can generally likewise be described by the general formula I.

The monomer A1B1 particularly preferably has the above-described general formula II or IIa.

As monomers AB or A1B1 of the general formula I, preference is given to using 2,2′-spiro[4H-1,3,2-benzodioxasilin], 2,2-dimethyl[4H-1,3,2-benzodioxasilin], 2,2-diphenyl[4H-1,3,2-benzodioxasilin], 2,2-dialkyl[4H-1,3,2-benzodioxasilin], 2-alkyl-2-methyl[4H-1,3,2-benzodioxasilin], 2-methyl-2-vinyl[4H-1,3,2-benzodioxasilin] or the compounds mentioned on page 20, lines 7 to 18 of WO 2011/000858 in the polymerization step for producing the composites of the invention. Processes for preparing various monomers AB and A1B2 are described in the respective descriptions and experimental parts of the above-mentioned publications WO 2010/112581, WO 2010/128144 and WO 2011/000858.

In the case of a copolymerization of the monomers AB and A1B1, the molar ratio of the two monomers can be varied within a wide range. The molar ratio of the monomers AB and A1B1 to one another is usually in the range from 5:95 to 9:1, frequently in the range from 1:9 to 4:1 or from 1:4 to 2:1, in particular in the range from 1:2 to 6:4. Particularly in cases in which AB is a monomer comprising a polyether-comprising radical, not more than 50% by weight, based on the total weight of the monomers used, of AB and at the same time at least 50% by weight of a monomer A1B1 of the general formula II or IIa are used.

It has been found that the polymerization of at least one monomer AB or the copolymerization of at least one monomer AB with at least one monomer A1B1 can advantageously be carried out in the presence of a polyether, as a result of which the component (C) comprised in the composite then corresponds to the polyether used in the process. In this case, the monomer AB does not have to comprise a polyether-comprising radical. The polyethers which can be used as component (C) and their preferred embodiments have been indicated above in the description of the component (C) of the composite of the invention.

In a further embodiment of the present invention, the component (C) used in the process of the invention for producing a composite is a polyether selected from the group consisting of polyethylene glycols, polypropylene glycols and copolymers of ethylene oxide and propylene oxide.

In a further embodiment of the present invention, the polymerization in the process of the invention for producing a composite is carried out in the presence of a further component (E) which is at least one inorganic (semi)metal oxide in the form of particles. Examples of such particles have been given above in the description of the component (E) of the composite of the invention.

The polymerization conditions in the process of the invention are selected so that, in the copolymerization of the monomers AB and A1B1, the monomer units which form the inorganic or (semi)metal-organic phase (a) and monomer units which form the organic polymer phase (b), i.e. the cationically polymerizable organic unit, polymerize synchronously. The term “synchronously” does not necessarily mean that the polymerizations of the first monomer unit and the second monomer unit proceed at the same rate. Rather, “synchronously” means that the polymerizations of the first monomer unit and the second monomer unit are kinetically coupled and triggered by the same polymerization conditions.

In the case of the monomers AB and A1B1, a synchronous polymerization is ensured when the copolymerization is carried out under cationic polymerization conditions. The copolymerization of the monomers AB and A1B1, especially the copolymerization of the monomers of the above-defined general formulae III and IIIa with monomers of the general formulae II and IIa, is, in particular, carried out in the presence of a protic catalyst or in the presence of aprotic Lewis acids. Preferred catalysts here are Brönstedt acids, for example organic carboxylic acids such as trifluoroacetic acid, trichloroacetic acid, formic acid, chloroacetic acid, dichloroacetic acid, hydroxyacetic acid (glycolic acid), lactic acid, cyanoacetic acid, 2-chloropropanoic acid, 2,3-bishydroxypropanoic acid, malic acid, tartaric acid, mandelic acid, benzoic acid or o-hydroxybenzoic acid, and also organic sulfonic acids such as methanesulfonic acid, trifluoromethanesulfonic acid or toluenesulfonic acid. Inorganic Brönstedt acids such as HCl, H₂SO₄ or HClO₄ are likewise suitable. As Lewis acid, it is possible to use, for example, BF₃, BCl₃, SnCl₄, TiCl₄ or AlCl₃. The use of complexed Lewis acids or Lewis acids dissolved in ionic liquids is also possible. The acid is usually used in an amount of from 0.1 to 10% by weight, preferably from 0.5 to 5% by weight, based on the total mass of the monomers.

Preferred catalysts are organic carboxylic acids, in particular organic carboxylic acids having a pKa (25° C.) in the range from 0 to 5, in particular from 1 to 4, e.g. trifluoroacetic acid, trichloroacetic acid, formic acid, chloroacetic acid, dichloroacetic acid, hydroxyacetic acid (glycolic acid), lactic acid, cyanoacetic acid, 2-chloropropanoic acid, 2,3-bishydroxypropanoic acid, malic acid, tartaric acid or o-hydroxybenzoic acid.

The polymerization or copolymerization carried out under cationic conditions is carried out in the presence of the base body composed of nonwoven (A), the polyether or the polyether-comprising radical (C), optionally the lithium salt (D) and optionally the inorganic (semi)metal oxide in the form of particles (E).

The polymerization can in principle be carried out in bulk or preferably at least partially in an inert solvent or diluent. Suitable solvents or diluents are organic solvents, for example halogenated hydrocarbons such as dichloromethane, trichloromethane, dichloroethene, chlorobutane or chlorobenene, aromatic hydrocarbons such as toluene, xylenes, cumene or tert-butylbenzene, aliphatic and cycloaliphatic hydrocarbons such as cyclohexane or hexane, cyclic or alicyclic ethers such as tetrahydrofuran, dioxane, diethyl ether, methyl tert-butyl ether, ethyl tert-butyl ether, diisopropyl ether and mixtures of the abovementioned organic solvents. Preference is given to organic solvents in which the monomers AB and A1B1 are sufficiently soluble under polymerization conditions (solubility at 25° C. at least 10% by weight). These include, in particular, aromatic hydrocarbons, cyclic and alicyclic ethers and mixtures of these solvents.

The polymerization of the monomer AB or the copolymerization of the monomers AB and A1B1 is preferably carried out in the substantial absence of water, i.e. the concentration of water at the beginning of the polymerization is less than 0.1% by weight. Accordingly, preference is given to using monomers which do not eliminate water under polymerization conditions as monomers AB and A1B1 or as monomers of the formula I. These include, in particular, the monomers of the formulae II, IIa, III and IIIa.

The polymerization can in principle be carried out in a wide temperature range, preferably in the range from 0 to 200° C., in particular in the range from 20 to 120° C.

In a further embodiment of the present invention, the polymerization in the process of the invention for producing a composite is carried out at a temperature in the range from 0 to 200° C.

The process of the invention for producing a composite is preferably carried out in such a way that the composite formed in the polymerization is obtained directly in the form of a thin layer.

In a first embodiment, a base body composed of nonwoven is firstly loaded with the starting compounds for the further components, i.e., in particular, the monomer AB or the monomers AB and A1B1 and optionally the polyether as component (C), the electrolyte salt (D) and/or the inorganic (semi)metal oxide particles (E) and, in a second process step, the monomer AB or the monomers AB and A1B1 are converted into the nanocomposite (B) in which the components (C), (D) and (E) are embedded in chemically unchanged form.

Processes for producing filled nonwovens are known in principle to those skilled in the art. Thus, a nonwoven can be loaded or filled partially to completely with the necessary starting components by, for example, impregnation, painting, doctor blade methods, calendering or combinations thereof. A nonwoven which has been filled in this way is subsequently subjected to conditions under which the polymerization or copolymerization takes place.

The composites obtained in this way are particularly suitable as separator or as constituent of a separator in electrochemical cells.

For the purposes of the present invention, the term electrochemical cell or battery encompasses batteries, capacitors and accumulators (secondary batteries) of any type, in particular alkali metal cells or batteries such as lithium, lithium ion, lithium-sulfur and alkaline earth metal batteries and accumulators, including in the form of high-energy or high-power systems, and also electrolyte capacitors and double-layer capacitors which are known under the names Supercaps, Goldcaps, BoostCaps or Ultracaps.

The present invention further provides for the use of the above-described composite of the invention as separator or as constituent of a separator in electrochemical cells, fuel cells or supercapacitors.

The present invention likewise provides a separator for an electrochemical cell, which comprises, in particular consists of, the above-described composite of the invention.

The present invention likewise provides a fuel cell, a battery or a capacitor comprising at least one separator according to the invention as described above.

The composites of the invention are preferably suitable for electrochemical cells which are based on the transfer of alkali metal ions, in particular for lithium metal, lithium-sulfur and lithium ion cells or batteries and especially for lithium ion secondary cells or secondary batteries. The composites of the invention are particularly suitable for electrochemical cells from the group of lithium-sulfur cells.

The present invention provides an electrochemical cell comprising at least one separator according to the invention as described above and

(X) at least one cathode and
(Y) at least one anode.

The electrochemical cell of the invention, in particular a rechargeable electrochemical cell, is preferably a cell in which charge transport within the cell is mainly brought about by lithium cations.

Particularly preferred electrochemical cells are therefore lithium ion cells, in particular lithium ion secondary cells, which have at least one separator layer made up of the composites of the invention. Such cells generally have at least one anode suitable for lithium ion cells, a cathode suitable for lithium ion cells, an electrolyte and at least one separator layer which is arranged between the anode and the cathode and comprises composites of the invention.

As regards suitable cathode materials, suitable anode materials, suitable electrolytes and possible arrangements, reference is made to the relevant prior art, e.g. appropriate monographs and reference works: e.g. Wakihara et al. (editor): Lithium ion Batteries, 1st edition, Wiley VCH, Weinheim, 1998; David Linden: Handbook of Batteries (McGraw-Hill Handbooks), 3^{rd} edition, Mcgraw-Hill Professional, New York 2008; J. O. Besenhard: Handbook of Battery Materials. Wiley-VCH, 1998.

Possible cathodes are, in particular, cathodes in which the cathode material comprises a lithium-transition metal oxide, e.g. lithium-cobalt oxide, lithium-nickel oxide, lithium-cobalt-nickel oxide, lithium-manganese oxide (spinel), lithium-nickel-cobalt-aluminum oxide, lithium-nickel-cobalt-manganese oxide or lithium-vanadium oxide, a lithium sulfide or lithium polysulfide such as Li₂S, Li₂S₈, Li₂S₆, Li₂S₄ or Li₂S₃ or a lithium-transition metal phosphate such as lithium-iron phosphate as electroactive constituent. Cathode materials which comprise iodine, oxygen, sulfur and the like as electroactive constituent are also suitable. However, if materials comprising sulfur or polymers comprising polysulfide bridges are to be used as cathode materials, it has to be ensured that the anode is charged with Li⁰ before such an electrochemical cell can be discharged and recharged.

The electrochemical cell of the invention further comprises at least one anode (Y) in addition to the separator of the invention and the cathode (X).

In an embodiment of the present invention, anode (Y) can be selected from among anodes composed of carbon, anodes comprising Sn or Si and anodes comprising lithium titanate of the formula Li₄₊ₓTi₅O₁₂ where x has a numerical value of from >0 to 3. Anodes composed of carbon can, for example, be selected from among hard carbon, soft carbon, graphene, graphite and in particular graphite, intercalated graphite and mixtures of two or more of the above-mentioned carbons. Anodes comprising Sn or Si can, for example be selected from among nanoparticulate Si or Sn powder, Si or Sn fibers, carbon-Si or carbon-Sn composites and Si-metal or Sn-metal alloys.

In a further embodiment of the present invention, the electrochemical cell of the invention has an anode (Y) selected from among anodes composed of carbon, anodes comprising Sn or Si and anodes comprising lithium titanate of the formula Li₄₊ₓTi₅O₁₂ where x has a numerical value of from >0 to 3.

Apart from the electroactive constituents, the anodes and cathodes can also comprise further constituents, for example
electrically conductive or electroactive constituents such as carbon black, graphite, carbon fibers, carbon nanofibers, carbon nanotubes or electrically conductive polymers;
binders such as polyethylene oxide (PEO), cellulose, carboxymethylcellulose (CMC), polyethylene, polypropylene, polytetrafluoroethylene, polyacrylonitrile-methyl methacrylate, polytetrafluoroethylene, styrene-butadiene copolymers, tetrafluoroethylene-hexafluoropropylene copolymers, polyvinylidene difluoride (PVdF), polyvinylidene difluoride-hexafluoropropylene copolymers (PVdF-HFP), tetrafluoroethylene-hexa-fluoropropylene copolymers, tetrafluoroethylene, perfluoroalkyl-vinyl ether copolymers, vinylidene fluoride-hexafluoropropylene copolymers, ethylene-tetrafluoroethylene copolymers, vinylidene fluoride-chlorotrifluoroethylene copolymers, ethylene-chloro-fluoroethylene copolymers, ethylene-acrylic acid copolymers (with and without inclusion of sodium ions), ethylene-methacrylic acid copolymers (with and without inclusion of sodium ions), ethylene-methacrylic ester copolymers (with and without inclusion of sodium ions), polyimides and polyisobutene.

The two electrodes, i.e. the anode and the cathode, are connected to one another in a manner known per se using a separator according to the invention and a liquid or solid electrolyte. For this purpose, it is possible, for example, to apply, e.g. laminate-on, a composite according to the invention to one of the two electrodes which is provided with a power outlet lead (anode or cathode), impregnate it with the electrolyte and subsequently apply the oppositely charged electrode which is provided with a power outlet lead, optionally roll up the sandwich obtained in this way and introduce it into a battery housing. It is also possible to layer the layer- or film-like constituents power outlet lead, cathode, separator, anode, power outlet lead to form a sandwich, optionally roll the sandwich, roll it up into a battery housing and subsequently impregnate the arrangement with the electrolyte.

Possible liquid electrolytes are, in particular, nonaqueous solutions (water content generally <20 ppm) of lithium salts and molten Li salts, e.g. solutions of lithium hexafluorophosphate, lithium perchlorate, lithium hexafluoroarsenate, lithium trifluoromethylsulfonate, lithium bis(trifluoromethylsulfonyl)imide or lithium tetrafluoroborate, in particular lithium hexafluorophosphate or lithium tetrafluoroborate, in suitable aprotic solvents such as ethylene carbonate, propylene carbonate and mixtures of these with one or more of the following solvents: dimethyl carbonate, diethyl carbonate, dimethoxyethane, methyl propionate, ethyl propionate, butyrolactone, acetonitrile, ethyl acetate, methyl acetate, toluene and xylene, especially in a mixture of ethylene carbonate and diethyl carbonate.

A separator layer according to the invention which is generally impregnated with the liquid electrolyte, in particular a liquid organic electrolyte, is arranged between the electrodes.

The present invention further provides for the use of electrochemical cells according to the invention in lithium ion batteries. The present invention further provides lithium ion batteries comprising at least one electrochemical cell according to the invention. Electrochemical cells according to the invention can be combined with one another, for example connected in series or in parallel, in lithium ion batteries according to the invention. Connection in series is preferred.

The present invention further provides for the use of electrochemical cells according to the invention as described above in automobiles, bicycles powered by an electric motor, aircraft, ships or stationary energy stores.

The present invention therefore also provides for the use of lithium ion batteries according to the invention in appliances, in particular in mobile appliances. Examples of mobile appliances are vehicles, for example automobiles, bicycles, aircraft or water vehicles such as boats or ships. Other examples of mobile appliances are those which are moved manually, for example computers, in particular laptops, telephones or electric hand tools, for example in the building sector, in particular drills, screwdrivers with rechargeable batteries or tackers with rechargeable batteries.

The use of lithium ion batteries according to the invention comprising separators according to the invention in appliances offers the advance of a longer period of operation before recharging, a lower capacity loss during prolonged operation and also a reduced risk of spontaneous discharge caused by a short circuit and destruction of the cell. If an equal period of operation were to be realized using electrochemical cells having a lower energy density, a higher weight of electrochemical cells would have to be accepted.

The monomers AB comprising at least one polyether-comprising radical, which can be used in the process of the invention for producing the composite of the invention are novel. Such specific monomers AB can be prepared by known methods which can also be used for preparing the monomers AB known in the literature, with the introduction of the polyether-comprising radical being carried out by methods which are known to those skilled in the art, in particular organic chemists.

The present invention also provides a monomer AB which
has at least one first cationically polymerizable monomer unit A which comprises a metal or semimetal M and
has at least one second cationically polymerizable organic monomer unit B which is bound via one or more covalent chemical bonds to the metal or semimetal M of the polymerizable monomer unit A,
   wherein the monomer AB comprises at least one polyether-comprising radical.

Preference is given to a monomer AB according to the invention in which M is Si, the cationically polymerizable organic monomer unit B is covalently bound via two oxygen atoms to M and the monomer unit A has two identical or different radicals which are selected from the group consisting of C₁-C₁₈-alkyl, vinyl, C₆-C₁₀-aryl, C₇-C₁₄-alkylaryl and polyether-comprising radicals comprising monomer units selected from the group consisting of ethylene oxide and propylene oxide and are each bound via a carbon atom to Si, where at least one of the two radicals bound via a carbon atom to Si is a polyether-comprising radical.

In an embodiment of the present invention, monomer AB is selected from among compounds of the general formula IIIa′

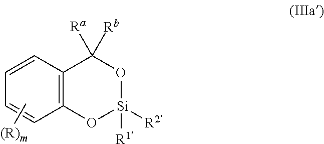

where
R the radicals R can be identical or different and are selected from among halogen, CN, C₁-C₆-alkyl, C₁-C₆-alkoxy and phenyl,
m is 0, 1 or 2, in particular 0,
R^{a}, R^{b} are each, independently of one another, hydrogen or methyl, in particular hydrogen,
R^{1′} is C₁-C₆-alkyl, C₃-C₆-cycloalkyl, a polyether-comprising radical which comprises monomer units selected from the group consisting of ethylene oxide and propylene oxide, and is bound via a carbon atom, or aryl or a radical Ar′—C(R^{a′},R^{b′})— where Ar′ has the meanings given for Ar and R^{a′}, R^{b′} have the meanings given for R^{a}, R^{b}, and
R^{2′} is a polyether-comprising radical which comprises monomer units selected from the group consisting of ethylene oxide and propylene oxide, in particular ethylene oxide, and is bound via a carbon atom.

In formula IIIa′, R^{1′} is preferably C₁-C₆-alkyl, in particular methyl.

In a particularly preferred embodiment of the present invention, the polyether-comprising radical bound via a carbon atom to Si in a preferred monomer AB is a radical of the formula C-PEG,

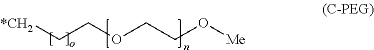

where
o is 0 or an integer from 1 to 18, preferably from 1 to 6, in particular 1, and
n is an integer from 1 to 100, preferably from 5 to 50, in particular from 8 to 30.

The invention is illustrated by the following examples which do not, however, restrict the invention.

Percentages indicated are in each case by weight, unless explicitly stated otherwise.

### I. Preparation of Monomers Comprising a Polyether-Comprising Radical

### I.1 Synthesis of 2-methyl-2-(3-(polyethylene glycol 500 ω-methyl ether)propanediyl-1)[4H-1,3,2-benzodioxasilin]

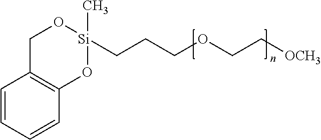 [0197] where n=11

### I.1.a Hydrosilylation of Polyethylene Glycol α-Allyl Ether ω-Methyl Ether by Means of Dichloromethylsilane

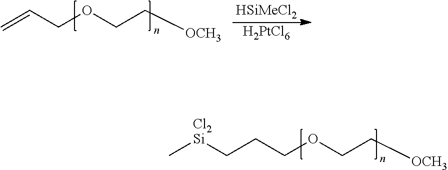 [0199] where n=11

To remove water, 250 g (0.46 mol) of polyethylene glycol α-allyl ether ω-methyl ether (commercially available as Uniox-MA 500 from NOF Corporation; n=11, M=540 g/mol, residual water content: 0.26% by weight determined by Karl-Fischer titration) were dissolved in 200 ml of water-free toluene under a nitrogen protective gas atmosphere and admixed with 10 g (0.09 mol) of trimethylchlorosilane (M=108.64 g/mol). The mixture was heated at 120° C. for 3 hours. After cooling to 20° C., toluene and further volatile compounds such as hexamethyldi-siloxane ((CH₃)₃SiOSi(CH₃)₃) were removed at 80° C./5 mbar.

0.8 μl of a solution of 205 mg of hexachloroplatinic(IV) acid hydrate (H₂PtCl₆*6 H₂O) in 0.5 ml of isopropanol were added to the dried allyl ether. 58.6 g (0.51 mol) of dichloromethylsilane (Cl₂SiH(CH₃), M=115 g/mol) were added dropwise at 50° C. over a period of 1 hour and the reaction mixture was subsequently stirred at 80° C. for another 2 hours. 301 g of product (M=655 g/mol) were obtained in quantitative yield.

¹H-NMR (CDCl₃, 500 Mhz): δ=0.7 ppm (3H, CH₃SiCl₂—R), 1.1-1.2 ppm (2H, m, RCl₂SiCH₂CH₂CH₂OR), 1.6-1.7 ppm (2H, m, RCl₂SiCH₂CH₂CH₂OR), 3.3 ppm (3H, s, —OCH₃), 3.4-3.5 ppm (2H, dd, RCl₂SiCH₂CH₂CH₂OR), 3.5-3.7 (44H, m, R(OCH₂CH₂)₁₁OCH₃).

### I.1.b Synthesis of 2-methyl-2-(3-(polyethylene glycol 500 ω-methyl ether)propanediyl-1)[4H-1,3,2-benzodioxasilin]

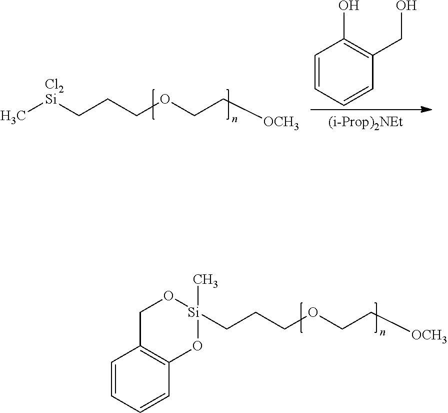 [0204] where n=11

58.3 g (0.45 mol) of diisopropylethylamine (Hünig Base, M=129.24 g/mol) which had previously been distilled over calcium hydride together with 28 g (0.22 mol) of 2-hydroxybenzyl alcohol (saligenin, M=124.1 g/mol) in 150 ml of water-free toluene were placed under a nitrogen atmosphere in a reaction vessel. 147 g (0.23 mol) of the dichlorosilane obtained in example 1.1.a (n=11, M=655 g/mol) were dissolved in 150 ml of water-free toluene and added dropwise to the first mixture over a period of 75 minutes, with the temperature not exceeding 40° C. The reaction mixture was subsequently heated to 80° C. and stirred at this temperature for 1 hour. After cooling to 20° C., the hydrochloride of diisopropylamine was filtered off and the solvent was removed at 80° C. and 5 mbar. 140 g of the desired product (87%, M=707 g/mol) were obtained.

¹H-NMR (CD₂Cl₂, 500 Mhz): δ=0.15 ppm (3H, CH₃Si—R), 0.55-0.65 (2H, m, R₃SiCH₂CH₂CH₂OR), 1.4-1.5 ppm (2H, m, R₃SiCH₂CH₂CH₂OR), 3.15 ppm (3H, s, —OCH₃), 3.2-3.3 ppm (2H, dd, R₃SiCH₂CH₂CH₂OR), 3.3-3.5 (44H, m, R(OCH₂CH₂)₁₁OCH₃), 4.75 ppm (2H, s, Ar—CH₂—OR), 6.7-7.1 ppm (4H, m, Ar—H).

### I.2 Synthesis of 2-methyl-2-(3-(polyethylene glycol 1000 ω-methyl ether)propanediyl-1)[4H-1,3,2-benzodioxasiline]

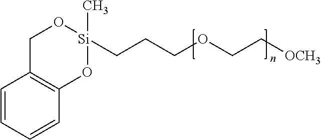 [0208] where n=22

### I.2.a Allylation of Polyethylene Glycol Methyl Ether by Means of Allyl Chloride

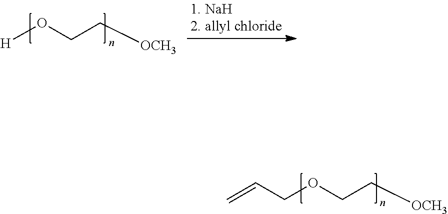 [0210] where n=22

Under a nitrogen atmosphere, 300 g (0.3 mol) of polyethylene glycol methyl ether (commercially available as Pluriol 1020 E from BASF SE; M=1000 g/mol) were dissolved in 350 ml of water-free tetrahydrofuran. A total of 13.2 g (0.33 mol) of sodium hydride (M=24.0 g/mol) as a 60% strength by weight dispersion in oil were added in small portions over a period of 45 minutes. To complete the reaction, the reaction mixture was subsequently stirred at 60° C. for 75 minutes. The solvent THF was removed on a rotary evaporator and dichloromethane was added to the residue. The organic phase was washed twice with water and dichloromethane was removed by distillation. 247 g of the allylated polyethylene glycol (78%, M=1040 g/mol) were obtained.

¹H-NMR (CDCl₃, 500 Mhz): δ=3.3 ppm (3H, s, —OCH₃), 3.4-3.6 (88H, m, CH₂═CH—CH₂(OCH₂CH₂)₂₂OCH₃), 3.9 ppm (2H, d, CH₂═CH—CH₂(OCH₂CH₂)₂₂OCH₃), 5.1, 5.2 ppm (2H, d, CH₂═CH—CH₂(OCH₂CH₂)₂₂OCH₃), 5.9 ppm (1H, m, CH₂═CH—CH₂(OCH₂CH₂)₂₂OCH₃).

### I.2.b Hydrosilylation of Polyethylene Glycol α-Allyl Ether ω-Methyl Ether by Means of Dichloromethylsilane

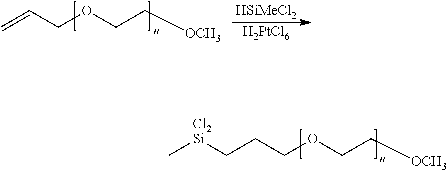 [0214] where n=22

Under a nitrogen atmosphere, 242 g (0.23 mol) of the polyethylene glycol α-allyl ether ω-methyl ether (n=22, M=1040 g/mol, residual water content: 0.26% by weight according to Karl-Fischer titration) obtained in example I.2.a together with 6 g (0.06 mol) of trimethylchlorosilane (M=108.64 g/mol) and 200 ml of dry toluene were placed in a reaction vessel and heated at 120° C. for 3 hours. After cooling to 20° C., toluene and further volatile compounds such as hexamethyldisiloxane ((CH₃)₃SiOSi(CH₃)₃) were removed at 80° C./4 mbar. 0.5 μl of a solution of 205 mg of hexachloroplatinic(IV) acid hydrate (H₂PtCl₆*6 H₂O) in 0.5 ml of isopropanol was added to the dried allyl ether. 29.7 g (0.26 mol) of dichloromethylsilane (Cl₂SiH(CH₃), M=115 g/mol) were added dropwise at 50° C. over a period of 1 hour and the reaction mixture was subsequently stirred at 80° C. for a further 2 hours. 272 g of product (M=1155 g/mol) were obtained in quantitative yield.

¹H-NMR (CDCl₃, 500 Mhz): δ=0.7 ppm (3H, CH₃SiCl₂—R), 1.1-1.2 ppm (2H, m, RCl₂SiCH₂CH₂CH₂OR), 1.6-1.7 ppm (2H, m, RCl₂SiCH₂CH₂CH₂OR), 3.3 ppm (3H, s, —OCH₃), 3.4-3.5 ppm (2H, dd, RCl₂SiCH₂CH₂CH₂OR), 3.5-3.7 (88H, m, R(OCH₂CH₂)₂₂OCH₃).

### I.2.c Synthesis of 2-methyl-2-(3-(polyethylene glycol 1000 ω-methyl ether)propanediyl-1)[4H-1,3,2-benzodioxasilin]

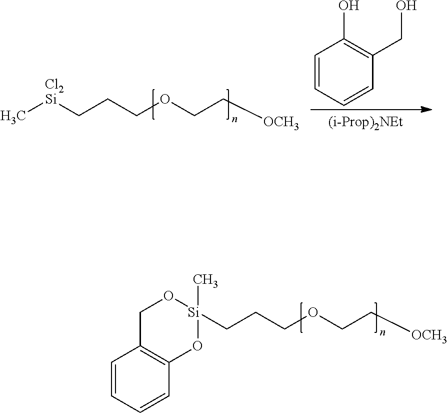 [0218] where n=22

60.4 g (0.47 mol) of diisopropylethylamine (Hünig Base, M=129.24 g/mol) which had previously been distilled over calcium hydride together with 29 g (0.224 mol) of 2-hydroxybenzyl alcohol (saligenin, M=124.1 g/mol) and 160 ml of water-free toluene were placed under a nitrogen atmosphere in a reaction vessel. 270.9 g (0.234 mol) of the dichlorosilane obtained in example I.2.a (n=22, M=1155 g/mol) were dissolved in 100 ml of water-free toluene and added dropwise to the first mixture over a period of 30 minutes, with the temperature not exceeding 40° C. The reaction mixture was subsequently heated to 80° C. and stirred at this temperature for 1 hour. After cooling to 20° C., the hydrochloride of diisopropylamine was filtered off and the solvent was removed at 80° C. and 5 mbar. 231 g of the desired product (82%, M=1207 g/mol) were obtained.

¹H-NMR (CD₂Cl₂, 500 Mhz): δ=0.05 ppm (3H, CH₃Si—R), 0.55-0.65 (2H, m, R₃SiCH₂CH₂CH₂OR), 1.3-1.4 ppm (2H, m, R₃SiCH₂CH₂CH₂OR), 3.05 ppm (3H, s, —OCH₃), 3.1-3.2 ppm (2H, dd, R₃SiCH₂CH₂CH₂OR), 3.3-3.5 (88H, m, R(OCH₂CH₂)₂₂OCH₃), 4.6 ppm (2H, s, Ar—CH₂—OR), 6.5-6.9 ppm (4H, m, Ar—H).

### II. Production of Composites According to the Invention

### II.1 General Method for Producing Composites According to the Invention

Polyethylene glycol methyl ether having a molecular weight of about 500 g/mol (commercially available as Pluriol® A 500E from BASF SE) and lithium trifluorosulfonimide (LiTFSI) were homogenized at 85° C. 266 mg (1.6 mmol) of 2,2-dimethyl[4H-1,3,2-benzodioxasilin] (prepared as described in Tetrahedron Lett. 24 (1983) 1273) were added thereto. The mixture was subsequently transferred into 436 mg (1.6 mmol) of molten 2,2′-spirobi[4H-1,3,2-benzodioxasilin] (prepared as described in WO 2011/000858, page 28, lines 9 to 19). To start the polymerization, an initiator solution comprising 5.45 mg of tin tetrachloride (SnCl₄) in 56 mg of d-chloroform (CDCl₃) was added.

The reactive monomer mixture was polymerized at 95° C. for 10 minutes and transferred in portions to a metal plate which had been preheated at 95° C. in a desiccator and bore PET nonwoven (commercially available as nonwoven “PES20” from APODIS Filtertechnik OHG; 8 g/m², thickness 20 μm, 5×3.5 cm in area) so that sheet-like composites having layer thicknesses of 30 to 90 μm were obtained. Polymerization was subsequently carried out at 95° C. under a stream of nitrogen in a drying oven for 3 hours and the specimens were then heated further at 195° C. under reduced pressure for 30 minutes.

| | PEG 500 | | | Conductivity at |
|---|---|---|---|---|
| | methyl ether | LiTFSI | Mechanical | 20° C. |
| | [mg] | [mg] | properties | [mS/cm] |
| KM 1 | 45 | 27 | elastic | 0.17 |
| KM 2 | 60 | 100 | elastic | 0.25 |
| KM 3 | 135 | 81 | elastic | 0.29 |
| KM 4 | 225 | 135 | elastic | 0.45 |
| nonwoven | | | | 0.43 |
| electrolyte | | | | 4.00 |

Electrolyte: 1M LiTFSI in dioxolane and dimethyl ether (1:1 vol/vol)

1. A composite comprising the components
(A) at least one base body composed of nonwoven;
(B) at least one nanocomposite comprising
(a) at least one inorganic or (semi)metal-organic phase (a) which comprises at least one metal or semimetal M; and
(b) at least one organic polymer phase (b), where the organic polymer phase (b) and the inorganic or (semi)metal-organic phase (a) form essentially cocontinuous phase domains and the average distance between two adjacent domains of identical phases is not more than 100 nm;
(C) at least one polyether or at least one polyether-comprising radical, where the polyether-comprising radical is covalently bound to the (semi)metal-organic phase (a) or organic polymer phase (b); and
(D) optionally, at least one lithium salt.

2. The composite according to claim 1, wherein the base body composed of nonwoven (A) has been penetrated at least partially by the nanocomposite (B).

3. The composite according to claim 1, wherein the base body composed of nonwoven (A) is made of organic polymers selected from the group of polymers consisting of polyolefins, polymers of heteroatom-comprising vinyl monomers, polyesters, polyamides, polyimides, polyether ether ketones, polysulfones and polyoxymethylene.

4. The composite according to claim 1, wherein the metal or semimetal M of the phase (a) is selected from among B, Al, Si, Ti, Zr, Hf, Ge, Sn, Pb, V, As, Sb, Bi and mixtures thereof.

5. The composite according to claim 1, wherein the metal or semimetal M comprises at least 90 mol %, based on the total amount of M, of silicon.

6. The composite according to claim 1, wherein the lithium salt (D) is selected from the group consisting of lithium hexafluorophosphate, lithium perchlorate, lithium hexafluoroarsenate, lithium trifluoromethylsulfonate, lithium bis(trifluoromethylsulfonyl)imide) and lithium tetrafluoroborate.

7. The composite according to claim 1, wherein the nanocomposite (B) is a polymerization product of at least one monomer AB which
has at least one first cationically polymerizable monomer unit A which comprises a metal or semimetal M and
has at least one second cationically polymerizable organic monomer unit B which is bound via one or more covalent chemical bonds to the polymerizable monomer unit A,
where the polymerization product is obtained under cationic polymerization conditions under which both the polymerizable monomer unit A and the polymerizable monomer unit B polymerize with rupture of the bond between A and B and the monomer AB is polymerized in the presence of the base body composed of nonwoven (A), the polyether or the polyether-comprising radical (C) and optionally the lithium salt (D).

8. A process for producing a composite comprising the components
(A) at least one base body composed of nonwoven;
(B) at least one nanocomposite comprising
(a) at least one inorganic or (semi)metal-organic phase (a) which comprises at least one metal or semimetal M; and
(b) at least one organic polymer phase (b);
(C) at least one polyether or at least one polyether-comprising radical, where the polyether-comprising radical is covalently bound to the (semi)metal-organic phase (a) or organic polymer phase (b); and
(D) optionally a lithium salt;
by polymerization of at least one monomer AB which
has at least one first cationically polymerizable monomer unit A which comprises a metal or semimetal M and
has at least one second cationically polymerizable organic monomer unit B which is bound via one or more covalent chemical bonds to the polymerizable monomer unit A,
under cationic polymerization conditions under which both the polymerizable monomer unit A and the polymerizable monomer unit B polymerize with rupture of the bond between A and B, where the polymerization is carried out in the presence of the base body composed of nonwoven (A), the polyether or the polyether-comprising radical (C) and optionally the lithium salt (D).

9. The process according to claim 8, wherein the metal or semimetal M of the monomer unit A in the monomers AB is selected from among B, Al, Si, Ti, Zr, Hf, Ge, Sn, Pb, V, As, Sb, Bi and mixtures thereof.

10. The process according to claim 9, wherein the metal or semimetal M of the monomer unit A comprises at least 90 mol %, based on the total amount of M, of silicon.

11. The process according to claim 8, wherein the monomers AB which have at least one monomer unit A and at least one monomer unit B are described by the general formula I, 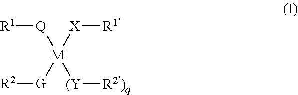
where
M is a metal or semimetal;
R¹, R² can be identical or different and are each a radical Ar—C(R^{a},R^{b})— where Ar is an aromatic or heteroaromatic ring which optionally has one or two substituents selected from among halogen, CN, C₁-C₆-alkyl, C₁-C₆-alkoxy and phenyl and R^{a}, R^{b} are each, independently of one another, hydrogen or methyl or together represent an oxygen atom or a methylidene group (═CH₂),
or the radicals R¹Q and R²G together form a radical of the formula Ia 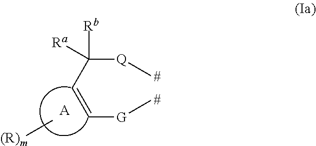
where A is an aromatic or heteroaromatic ring fused onto the double bond, m is 0, 1 or 2, the radicals R can be identical or different and are selected from among halogen, CN, C₁-C₆-alkyl, C₁-C₆-alkoxy and phenyl and R^{a}, R^{b} are as defined above;
G is O, S or NH;
Q is O, S or NH;
q is, according to the valence of M, 0, 1 or 2,
X, Y can be identical or different and are each O, S, NH or a chemical bond;
R^{1′}, R^{2′} can be identical or different and are each C₁-C₆-alkyl, C₃-C₆-cycloalkyl, a polyether-comprising radical comprising monomer units selected from the group consisting of ethylene oxide and propylene oxide, or aryl or a radical Ar′—C(R^{a′},R^{b′})—, where Ar′ has the meanings given for Ar and R^{a′}, R^{b′} have the meanings given for R^{a}, R^{b} or R^{1′}, R^{2′} together with X and Y form a radical of the formula Ia as defined above;
or, when X is oxygen, the radical R^{1′} can be a radical of the formula Ib: 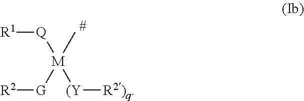
where q, R¹, R², R^{2′}, Y, Q and G are as defined above and # represents the bond to X.

12: The process according to claim 7, wherein the polymerization of at least one monomer AB is a copolymerization of at least one monomer AB which
has at least one first cationically polymerizable monomer unit A having a metal or semimetal M and at least one radical which is selected from the group consisting of C₁-C₂₀-hydrocarbon radicals and polyether-comprising radicals, and is covalently bound via a carbon atom to M and
has at least one second cationically polymerizable organic monomer unit B which is bound via one or more covalent chemical bonds to the polymerizable unit A,
with at least one monomer A 1B1 which
has at least one first cationically polymerizable monomer unit A1 having a metal or semimetal M and
has at least one second cationically polymerizable organic monomer unit B1 which is bound via one or more covalent chemical bonds to the polymerizable monomer unit A1,
where the copolymerization is carried out under cationic polymerization conditions under which both the polymerizable monomer units A and A1 and also the polymerizable monomer units B and B1 polymerize with rupture of the bond between A and B and with rupture of the bond between A1 and B 1.

13. The process according to claim 12, wherein the metals or semimetals M in the monomers AB and in the monomers A1B1 are each, independently of one another, Si, Al, Ti or Zr and the cationically polymerizable organic monomer units B and B1 in the corresponding monomers AB and A1B1 are each covalently bound via one or more oxygen atoms to M.

14. The process according to claim 12, wherein the metal or semimetal M in the monomer AB is Si and the monomer unit A has two identical or different radicals which are selected from the group consisting of C₁-C₁₈-alkyl, vinyl, C₆-C₁₀-aryl, C₇-C₁₄-alkylaryl and polyether-comprising radicals comprising monomer units selected from the group consisting of ethylene oxide and propylene oxide, and are each bound via a carbon atom to Si.

15. The process according to claim 8, wherein the component (C) is a polyether selected from the group consisting of polyethylene glycols, polypropylene glycols and copolymers of ethylene oxide and propylene oxide.

16. The process according to claim 8, wherein the polymerization is carried out in the presence of a further component (E) which is at least one inorganic (semi)metal oxide in the form of particles.

17. The process according to claim 8, wherein the polymerization is carried out at a temperature in the range from 0 to 200° C.

18. (canceled)

19. A separator for an electrochemical cell, which comprises composite according to claim 1.

20. An electrochemical cell comprising at least one separator according to claim 19 and
(X) at least one cathode and
(Y) at least one anode.

21. The electrochemical cell according to claim 20, wherein anode (Y) is selected from among anodes composed of carbon, anodes which comprise Sn or Si and anodes comprising lithium titanate of the formula Li₄₊ₓTi₅O₁₂ where x has a numerical value of from >0 to 3.

22. (canceled)

23. A lithium ion battery comprising at least one electrochemical cell according to claim 20.

24. The use of electrochemical cells according to claim 20 in automobiles, bicycles powered by an electric motor, aircraft, ships or stationary energy stores.

25. A monomer AB which
has at least one first cationically polymerizable monomer unit A which comprises a metal or semimetal M and
has at least one second cationically polymerizable organic monomer unit B which is bound via one or more covalent chemical bonds to the metal or semimetal M of the polymerizable monomer unit A,
wherein the monomer AB comprises at least one polyether-comprising radical.

26. The monomer according to claim 25, wherein M is Si, the cationically polymerizable organic monomer unit B is covalently bound via two oxygen atoms to M and the monomer unit A has two identical or different radicals which are selected from the group consisting of C₁-C₁₈-alkyl, vinyl, C₆-C₁₀-aryl, C₇-C₁₄-alkylaryl and polyether-comprising radicals comprising monomer units selected from the group consisting of ethylene oxide and propylene oxide and are each bound via a carbon atom to Si, where at least one of the two radicals bound via a carbon atom to Si is a polyether-comprising radical.

27. The monomer AB selected from among compounds of the general formula IIIa′ 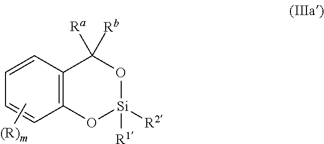
where
R the radicals R can be identical or different and are selected from among halogen, CN, C₁-C₆-alkyl, C₁-C₆-alkoxy and phenyl,
m is 0, 1 or 2,
R^{a}, R^{b} are each, independently of one another, hydrogen or methyl,
R^{1′} is C₁-C₆-alkyl, C₃-C₆-cycloalkyl, a polyether-comprising radical which comprises monomer units selected from the group consisting of ethylene oxide and propylene oxide, and is bound via a carbon atom, or aryl or a radical AC-C(R^{a′},R^{1b′})— where Ar′ has the meanings given for Ar and R^{a′}, R^{b′} have the meanings given for R^{a}, R^{b}, and
R^{2′} is a polyether-comprising radical which comprises monomer units selected from the group consisting of ethylene oxide and propylene oxide and is bound via a carbon atom.

28. The monomer AB according to claim 26, wherein the polyether-comprising radical bound via a carbon atom to Si is a radical of the formula C-PEG, 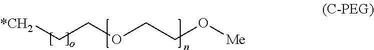
where
o is 0 or an integer from 1 to 18, and
n is an integer from 1 to 100.
